(19) United States
(12) Patent Application Publication
(10) Pub. No.: US 2009/0327331 A1
(43) Pub. Date: Dec. 31, 2009

(54) AD SYSTEM THAT INTERACTS WITH PLURAL AD ENGINES

(75) Inventors: Ashvin J. Mathew, Kirkland, WA (US); Nathan W. Brixius, Seattle, WA (US); Xiaoqiao Li, Issaquah, WA (US); Amit Arora, Redmond, WA (US)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 12/164,441

(22) Filed: Jun. 30, 2008

(51) Int. Cl. G06F 17/30

(52) U.S. Cl. 707/102; 707/103 R; 707/E17.055; 707/E17.045

(57) ABSTRACT

An ad system allows a user to create and manage an ad campaign that is administered by two or more ad engines. The ad system interacts with the ad engines using a channel abstraction interface module. For each ad engine, the channel abstraction interface module translates ad information from an engine-agnostic format that is associated with the ad system to an engine-specific format that is associated with the ad engine.

### BACKGROUND

Electronic ad campaigns are now a ubiquitous aspect of our network experience. A typical ad campaign includes one or more ad groups. An ad group, in turn, may include one or more keywords and one or more ad objects. In operation, an ad engine presents an ad object to a user upon the occurrence of a keyword-related triggering event. For example, the ad engine work may work in conjunction with a search provider. In this case, the ad engine can present an ad object to the user when the user enters a triggering keyword as a search term. Or the ad engine may present an ad object to the user when the user views network-delivered content that includes the triggering keyword.

In one approach, an ad engine may allow advertisers to compete for the opportunity to present ad objects via its services. For example, the ad engine may allow advertisers to specify bid amounts associated with their keywords. If a user enters a keyword, such as “power drill,” the ad engine determines whether there are any active bids associated with this keyword. If so, the ad engine may display the n ad objects associated with the n highest bids. (The presentation of ad objects may also be based on other considerations, such as the assessed relevance of the ad objects to the user.) For this reason, an advertiser is typically keenly interested in selecting appropriate bids for its keywords (as well as selecting appropriate keywords). If the advertiser bids too little, it may lose the opportunity to present its ad objects via the ad engine. If the advertiser bids too much, it may inefficiently exhaust its advertising budget.

### SUMMARY

In one illustrative implementation, an ad system is provided which allows a user to administer an ad campaign using the services of two or more ad engines. The ad system interacts with the ad engines using a channel abstraction interface module. For each ad engine, the channel abstraction interface module translates ad information from an engine-agnostic format to an engine-specific format that is associated with the ad engine.

According to another illustrative feature, a client abstraction interface module can be provided that allows the ad system to interact with at least one client module. The client abstraction interface module is capable of converting ad information between a client-specific format (associated with a particular client module) and a client-agnostic format (used by the ad system).

According to another illustrative feature, a presentation module can be provided that presents a collection of user interface presentations. These user interface presentations allow a user to interact with the ad system via the client abstraction interface module. The user interface presentations allow the user to efficiently create, edit, and monitor the performance of a multi-engine ad campaign.

According to another illustrative feature, a data interface module can be provided for managing the storage of ad information based on an object model. The object module may store ad information using a collection of engine-agnostic information objects and a collection of engine-specific information objects.

Other illustrative features correspond to methods, data structures, computer readable media, etc. for creating and managing an ad campaign using two or more ad engines.

This Summary is provided to introduce a selection of concepts in a simplified form; these concepts are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

FIG. 1 shows an illustrative ad system for administering an ad campaign using one or more ad engines.

FIG. 2 shows an illustrative presentation module for presenting a collection of user interface (UI) presentations to a user.

FIG. 3 shows an illustrative UI presentation for listing one or more ad groups in an ad campaign.

FIG. 4 shows an illustrative UI presentation for inputting group details associated with a new ad group.

FIG. 5 shows an illustrative UI presentation for receiving a user's selection of keywords used by the new ad group.

FIG. 6 shows another illustrative UI presentation for receiving the user's selection of keywords.

FIG. 7 shows an illustrative UI presentation that allows a user to enter bids for selected keywords; this illustrative UI presentation may also present the estimated performance of the selected keywords.

FIG. 8 shows an illustrative UI presentation for receiving the user's selection of an ad object associated with the new ad group.

FIG. 9 shows an illustrative UI presentation for previewing the new ad group that has been created; the new ad group may be implemented by plural ad engines, as indicated in this figure.

FIG. 10 shows an illustrative UI presentation that shows an updated list of ad groups, including the newly created ad group.

FIG. 11 shows an illustrative UI presentation that shows the performance of the new ad group on a per-engine basis; this UI presentation also offers the user an opportunity to edit the new ad group.

FIG. 12 shows an illustrative UI presentation that shows the performance of the new ad group on a per-keyword basis for a particular ad engine; this UI presentation also allows a user to edit the keywords associated with the new ad group.

FIG. 13 shows an illustrative UI presentation for displaying a summary of the performance of the new ad group with respect to one of the ad engines.

FIG. 14 shows additional information regarding an illustrative ad service module used in the ad system of FIG. 1.

FIG. 15 shows a type of illustrative ad service action module that can be used by the ad service module of FIG. 14.

FIG. 16 shows another type of illustrative ad service action module that can be used by the ad service module of FIG. 14.

FIG. 17 shows an example of ad information expressed using an illustrative object module.

FIG. 18 shows additional information regarding an illustrative abstraction user interface module used in the ad system of FIG. 1.

FIG. 19 is a procedure that provides an overview of one illustrative manner of operation of the ad system of FIG. 1 (or some other ad system).

FIG. 20 is a procedure that shows one illustrative way of creating an ad campaign using the ad system of FIG. 1 (or some other ad system).

FIG. 21 is a procedure that shows one illustrative way of reviewing the performance of an existing ad campaign using the ad system of FIG. 1 (or some other ad system).

FIG. 22 is a procedure that shows one illustrative way of editing an existing ad campaign using the ad system of FIG. 1 (or some other ad system).

FIG. 23 is a procedure that shows one illustrative way of exchanging ad information between the ad system of FIG. 1 (or some other ad system) and one or more ad engines.

FIG. 24 shows illustrative processing functionality that can be used to implement any aspect of the features shown in the foregoing drawings.

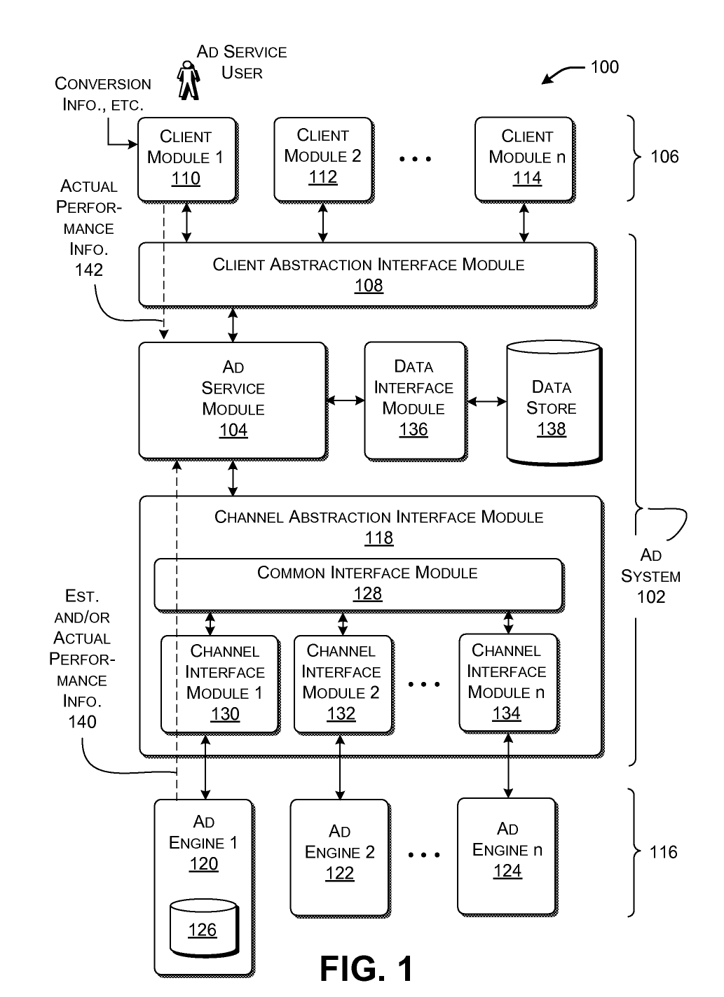

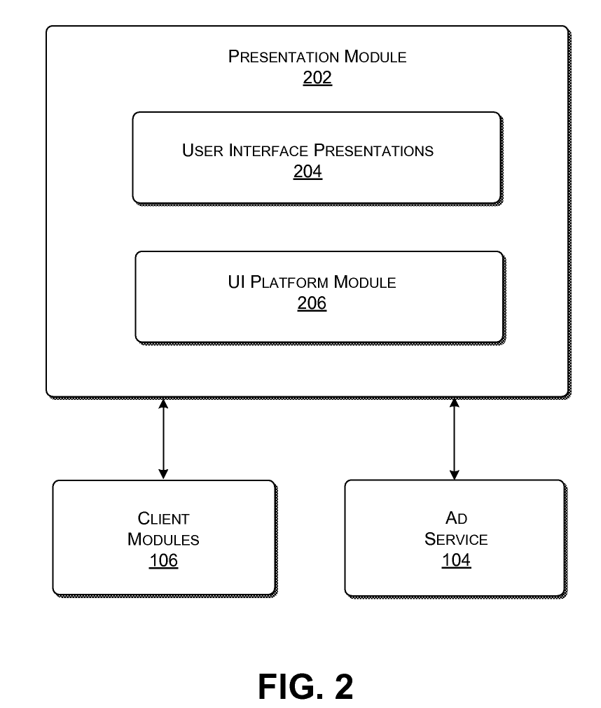

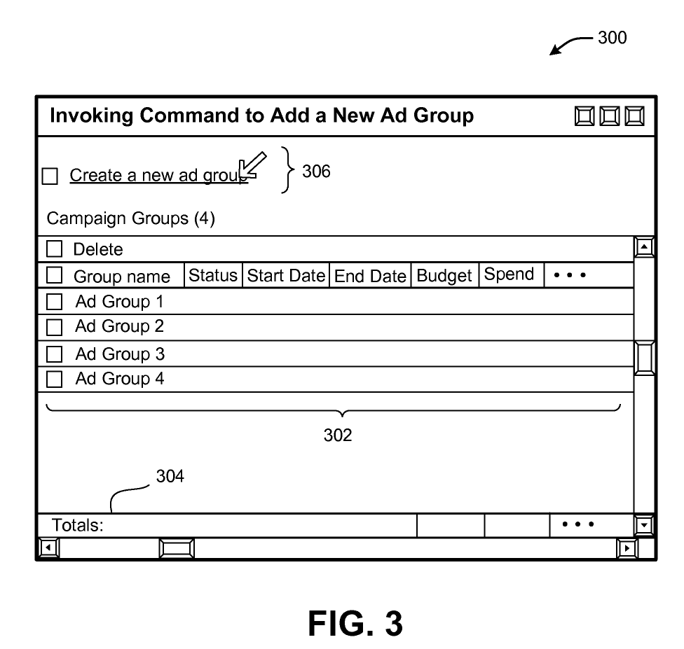

The same numbers are used throughout the disclosure and figures to reference like components and features. Series 100 numbers refer to features originally found in FIG. 1, series 200 numbers refer to features originally found in FIG. 2, series 300 numbers refer to features originally found in FIG. 3, and so on.

### DETAILED DESCRIPTION

In one technique, an advertiser can create and manage its ad campaign by directly interacting with an ad engine. This approach may pose various challenges. For example, the advertiser may find the process of setting up an ad campaign to be tedious. The difficultly associated with setting up and managing an ad campaign may be compounded in those cases in which the advertiser decides to run an ad campaign on multiple ad engines. In this case, the advertiser performs the potentially cumbersome task of separately interacting with two or more ad engines, each of which may be governed by a unique set of rules. Moreover, the advertiser may find the creation process fraught with uncertainty. This is because the advertiser may lack appropriate guidance on the selection of keywords and bidding amounts.

If the ad campaign performs poorly, the advertiser may choose to revise its ad campaign and re-launch it using the same ad engine. Or the user may decide to select another ad engine to implement its ad campaign. These types of ad hoc corrective operations may add to the complexity (and experienced frustration) of setting up and managing an effective ad campaign.

This disclosure sets forth an ad system that allows a user to create and manage an ad campaign that utilizes the services of any number of ad engines. The ad system is potentially an effective advertising tool because it broadens the reach of advertising campaigns to plural ad engines. The ad system is also potentially efficient because it allows a user to interact with plural ad engines using a common interface. The ad system is also potentially informative because it allows the user to compare the performance of different ad engines in implementing the ad campaign. More generally, the concepts disclosed herein may address one or more of the challenges or problems previously noted, but are not limited to addressing all or any of these challenges or problems.

This disclosure is organized as follows. Section A describes an illustrative system for administering an ad campaign using plural ad engines. Section B describes illustrative methods for performing the same function. Section C describes illustrative processing functionality that can be used to implement any aspect of the features described in Sections A and B.

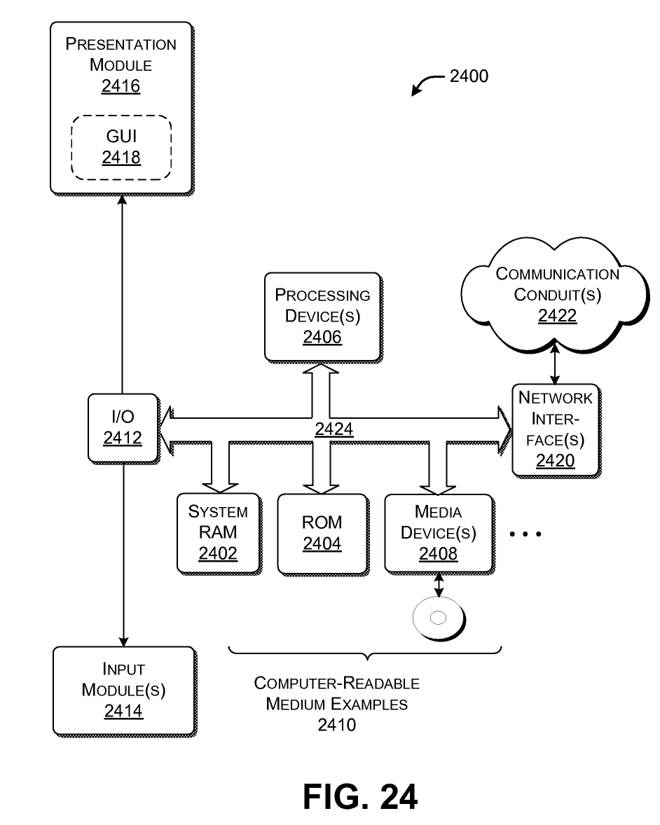

As a preliminary matter, some of the figures describe the concepts in the context of one or more components, variously referred to as functionality, modules, features, elements, etc. The various components shown in the figures can be implemented in any manner, for example, by software, hardware, firmware, manual processing operations, and so on, or any combination of these implementations. In one case, the illustrated separation of various components in the figures into distinct units may reflect the use of corresponding distinct physical components. Alternatively, or in addition, any single component illustrated in the figures may be implemented by plural physical components. Alternatively, or in addition, the depiction of any two or more separate components in the figures may reflect different functions performed by a single physical component. FIG. 24, to be discussed in turn, provides additional details regarding one illustrative implementation of the functions shown in the figures.

Other figures describe the concepts in flowchart form. In this form, certain operations are described as constituting distinct blocks performed in a certain order. Such implementations are illustrative and non-limiting. Certain blocks described herein can be grouped together and performed in a single operation, certain blocks can be broken apart into plural component blocks, and certain blocks can be performed in an order that differs from that which is illustrated herein. The blocks shown in the flowcharts can be implemented by software, firmware, hardware, manual processing, any combination of these implementations, and so on.

As to terminology, an ad campaign encompasses any program for presenting advertising content to one or more recipients. In one case, an ad campaign may refer to the most encompassing level at which an ad program is conducted. But, in other cases, an ad campaign may be a component part of a more encompassing ad campaign. As such, the term ad campaign is used very broadly herein to refer to any definable unit of an ad program.

In one example, the ad campaign may have component parts. For example, in one non-limiting case, an ad campaign may include one or more ad groups. An ad group may itself include one or more component parts. For example, in one non-limiting case, an ad group can include one or more keywords and one or more ad objects.

A keyword may correspond to or encompass textual information (and/or other type of information) that, when present, triggers the presentation of one or more ad objects.

An ad object may correspond to or encompass any advertising-related message that can be presented to a user. More specifically, the ad object can have any style, size, behavior, form of presentation (graphical, textual, audible, etc., or combination thereof), and so on. In a typical but non-limiting case, an ad object corresponds to a message that an ad engine presents to a user in the course of the user's interaction with a network-related service, such as a search service.

The general term ad information may encompass any information associated with an ad campaign or to an advertising operation in general. A particular unit of ad information is referred to as an object. For example, an “ad information object” generically refers to any item (or items) of an ad campaign. In other cases, the term object is used to refer to specific parts of an ad campaign. For example, as stated above, an “ad object” refers to a part of an ad campaign that delivers an advertising-related message.

The term user encompasses any entity which interacts with an advertising environment. In one case, a user refers to a person or entity which acts as an advertiser (or which is acting on behalf of an advertiser). This person or entity may set up and manage an ad campaign. In other contexts, a user may refer to an end-user who is the recipient of an ad object created by an advertiser.

The phase “configured to” encompasses any way that any kind of functionality can be constructed to perform an identified operation. The functionality can be configured to perform an operation using, for instance, hardware, software, firmware, etc., and/or any combination thereof.

A. Illustrative Systems

A.1. System Overview

FIG. 1 shows an illustrative ad administration environment 100 in which an ad campaign can be implemented. The ad administration environment 100 may generally correspond to a network-related environment, such as, but not limited to, an Internet or other WAN-related environment. In this illustrative environment, a recipient-type user receives ad objects in the course of interacting with one or more network-related services, such as one or more search services. An advertiser-type user creates the ad campaign that delivers these ad objects.

The ad administration environment includes an ad system 102. The ad system 102 includes a set of functionality for creating and managing an ad campaign. In one implementation, the ad system 102 can be physically implemented by one or more server-type computers, one or more data stores, and/or other data processing equipment (not shown). The components of the ad system 102 can be located at a single site or distributed over plural sites.

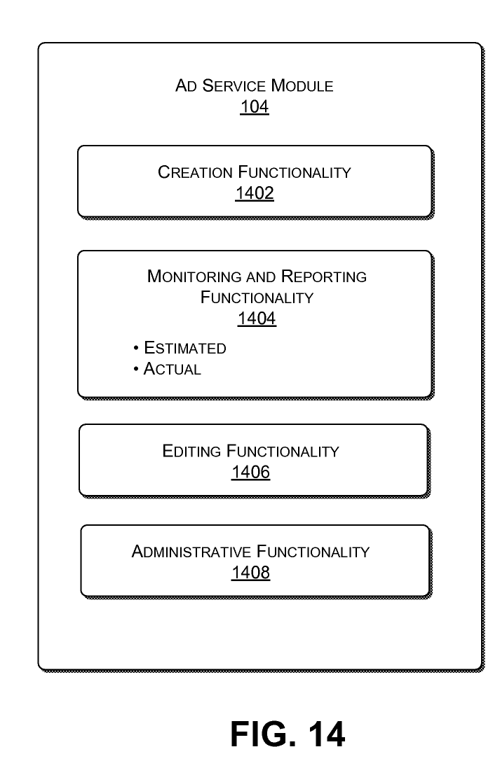

The ad system 102 includes an ad service module 104. The ad service module 104 performs core functions of the ad system 102. For example, the ad service module 104 provides functionality which allows an advertiser-type user (“user” for brevity below) to create an ad campaign. The ad service module 104 may also include functionality that allows a user to edit an existing ad campaign. The ad service module 104 may also include functionality which allows a user to monitor the performance of a new or existing ad campaign. The performance may correspond to the estimated performance of an ad campaign (e.g., especially in the case of a new ad group), the actual performance of an ad campaign, or any combination of the estimated and actual performance of the ad campaign. (To repeat, the term “ad campaign” is being used in a general sense herein to refer to any unit of an ad program, such as an ad group.) FIGS. 14-16 provide additional illustrative details regarding the ad service module 104.

The ad service module 104 interacts with one or more client modules 106 via a client abstraction interface module 108. FIG. 1 shows three representative client modules (110, 112, . . . 114), although the ad service module 104 can interact with any number of client modules 106. A client module refers to any functionality that can be used by an advertiser-type user to interact with the ad service module 104 (or, more generally, the ad system 102). In one case, a representative client module 110 may correspond to any kind of computing device that a user can use to access the ad system 102. For example, the representative client module 110 can correspond to a personal computer that is coupled to the ad system 102 via browsing functionality (not shown) implemented by the client module 110. In another case, the representative client module 110 can correspond to a system for performing any function that is provided by any type of organization or entity. For example, the representative client module 110 can correspond to a customer relationship management (CRM) system provided by a company or the like. If the representative client module 110 corresponds to a system, it may be implemented by one or more server-type computers, one or more data stores, and/or other data processing equipment (not shown). In this case, a user may access the ad system 102 via the server-type computers maintained by the representative client module 110. Still other implementations of the representative client module 110 are possible. Further, the ad system 102 can interact with different types of client modules 106.

Any type of communication conduit can be used to couple the client modules 106 with the ad system 102, such as a LAN-type connection, a WAN-type connection (e.g., Internet-type connection), a point-to-point-type connection, and so on.

The client abstraction interface module 108 provides functionality for allowing the ad service module 104 to interact with different types of client modules 106. The client abstraction interface module 108 performs this task by converting between a format that is native to any particular client module and a client-agnostic format used by the ad system 102. That is, for instance, when receiving information from the representative client module 110, the client abstraction interface module 108 converts the information from a native format (e.g., a client-specific format) that is appropriate to client module 110 to a generic format that is appropriate to the ad system 102. When providing information to the client module 110, the client abstraction interface module 108 converts the information from the generic format that is appropriate to the ad system 102 to the native format that is used by the client module 110.

The client abstraction interface module 108 can optionally include additional features. For example, consider the case in which the client abstraction interface module 108 is converting information from a client-specific format to a client-agnostic format. In this process, the client abstraction interface module 108 can apply information that was previously collected from the appropriate client module (or from some other source). For example, the client module may specify budget information without expressly identifying the currency associated with the budget information. The client abstraction interface module 108 can automatically use currency information that was previously supplied by the client module (or by some other source) when interpreting the budget information specified by the client module.

The ad service module 104 also communicates with one or more ad engines 116 via a channel abstraction interface module 118. FIG. 1 specifically shows three illustrative ad engines (120, 122, . . . 124), but the ad service module 104 can interact with any number of ad engines. An ad engine refers to any functionality for implementing an ad campaign. In one case, the implementation of an ad campaign entails monitoring the behavior of a recipient-user to determine the occurrence of triggering events. Upon the occurrence of a triggering event, the ad engine may present one or more ad objects to the recipient-user. For example, the representative ad engine 120 may corresponds to an engine that complements a search service. In this context, the representative ad engine 120 may monitor keywords entered as search terms by the user. If the user enters a keyword that is associated with an ad object, the representative ad engine 120 may present the ad object to the user. In particular, the representative ad engine 120 may decide to present the n ad objects associated with the n highest bids for the particular triggering keyword. (The presentation of ad objects can also be based on other factors, such as the assessed relevance of the ad objects.) As noted above, an ad object can have any style, size, form, behavior, etc. No limitation is placed herein on what may constitute an ad object; an ad object generally corresponds to any unit of information that delivers an advertising-related message to a user.

The representative ad engine 120 can present ad objects in response to other triggering events. For example, the representative ad engine 120 can also present ad objects in response to triggering keywords in content that has been delivered to the user, even though the user did not expressly enter these keywords. Ad objects can be delivered to users in yet other contexts.

In addition to presenting ad objects, any of the ad engines 116 can also perform administrative functions. For example, the representative ad engine 120 can allow an advertiser-type user to set up an ad group and then monitor the performance of this ad group. In one case, the representative ad engine 120 can monitor the actual performance of the ad group. Various known techniques exist for monitoring the performance of an ad group. For example, the representative ad engine 120 can monitor the number of times that an ad object has been delivered to recipient-type users (e.g., to provide an impressions-type count). In addition, or alternatively, the representative ad engine 120 can monitor any type of express actions that recipient-type users may have taken in response to receiving the ad object, such as by clicking on the ad object. In this way, the representative ad engine 120 can collect well-known performance metrics, such as click-through rate (CTR) information. In general, the representative ad engine 120 can include one or more data stores 126 for storing any type of accounting information associated with the dissemination of ad objects.

The representative ad engine 120 can also estimate the performance of an ad group. This may be appropriate in the case in which an ad group has not yet been launched. The representative ad engine 120 can perform this task based on historical records provided in the data store 126 and/or based on other considerations. For example, suppose that a particular advertiser-type user creates a new ad group that includes the keyword “kayak.” The representative ad engine 120 can estimate the performance of this keyword based on the prior performance of this keyword in the context of other ad campaigns (created by any advertiser-type user). Alternatively, or in addition, the representative ad engine 120 can estimate the performance of the keyword “kayak” based on the particular advertiser-type user's prior use of this keyword in other ad campaigns (or based on the advertiser-type user's prior use of a similar keyword, such as “canoe”). In general, the ad engines 116 can apply any type of algorithm for estimating the performance of an ad group.

The representative ad engine 120 can also perform customer-related administrative tasks. For example, the ad engine 120 can provide functionality which allows users to establish accounts, terminate accounts, change account settings, and so on. By “signing up” to use the ad engine 120, a user receives the right to use the ad-related services that the ad engine 120 exposes to external entities (e.g., as described above). An already “signed up” user can change her account settings, for example, by changing the payment instrument that is used to pay for the ad engine's 120 services.

Any of the ad engines 116 can be physically implemented by one or more server-type computers, one or more data stores, and/or other data processing equipment (not shown). Any type of communication conduit can be used to couple the ad engines 116 with the ad system 102, such as a LAN-type connection, a WAN-type connection (e.g., an Internet-type connection), point-to-point-type connection, and so on. In one case, the ad system 102 may directly interact with interfaces exposed by the ad engines 116. In other case, the ad system 102 may interact with the ad engines 116 via web services (or the like) provided by the respective ad engines 116. Recipient-type users (e.g., end-users) can interact with the ad engines 116 in the typical manner, e.g., by accessing the ad engines 116 via browsing functionality provided by the users' computing devices.

Further, each ad engine has been illustrated as a single entity to facilitate discussion. But any ad engine can include multiple components for performing different functions. For example, in one alternative case, a first component can determine which ads to present to a recipient user in a particular situation and a second component can actually deliver the ad content to the user.

In one case, different entities can administer different respective ad engines 116. Further, different ad engines 116 may use different respective protocols for implementing an ad campaign. For example, the protocol of an ad engine may govern, in part, how the ad engine interacts with external entities. In other words, the protocol of an ad engine may govern the format of ad information that is received by the ad engine from an external entity and the format of ad information that is provided by the ad engine to the external entity. Here, the term format is used very broadly to refer to any aspect of the ad information, such as the information items that are included in the ad information, and/or the way that the ad information is presented.

The ad system 102 processes ad information in a format that is independent of the particularities of the protocols used by the ad engines 116. In other words, the ad system 102 processes the ad information in an engine-agnostic manner. To accommodate this feature, the channel abstraction interface module 118 converts ad information between the engine-agnostic format used by the ad system 102 and the engine-specific format used by the ad engines 116.

More particularly, in one implementation, the channel abstraction interface module 118 includes a common interface module 128 and a collection of channel interface modules (130, 132, . . . 134). The common interface module 128 includes a general purpose set of methods for interacting with the ad engines 116 in an engine-agnostic manner. That is, these methods define a general interface that does not take account for the particularities of each ad engine. Each channel interface module, on the other hand, is designed to translate between the engine-agnostic representation of ad information (used by the common interface module 128) and engine-specific representation associated with a particular ad engine. For example, the channel interface module 130 is designed to account for the particularities of the protocol used by the ad engine 120, the channel interface module 130 is designed to account for the particularities of the protocol used by the ad engine 122, and the channel interface 132 is designed to account for the particularities of the protocol used by the ad engine 124.

An exchange between the ad system 102 and a particular ad engine may be performed as follows. A generic method may be invoked in the common interface module 128 which requires interaction with the representative ad engine 120. For example, the ad service module 104 may invoke the common interface module 128 to instruct the representative ad engine 120 to create a new ad group or to update an existing ad group. In this case, the common interface module 128 may provide a data structure which includes information associated with this request, referred to herein as request-related information. The information in this data structure is expressed in an engine-agnostic format. The channel interface module 130 converts the request-related information from the engine-agnostic format to an engine-specific format that is appropriate for the ad engine 120. The channel interface module 130 then contacts the ad engine 120 using the converted request-related information using, for example, a web service hosted by the ad engine 120 or using some other technique.

The ad engine 120 processes the request and returns a reply. The reply may include reply-related information associated therewith. The reply-related information may be expressed in an engine-specific format that is associated with the protocol used by the ad engine 120. The channel interface module 130 receives the reply-related information and converts it into an engine-agnostic format so that it can be processed in generic format by the ad system 102. FIG. 18, to be discussed in turn, provides additional information regarding one illustrative implementation of the channel abstraction interface module 118.

In the example above, the channel abstraction interface module 118 interacts with the ad engine 120 to create or update some ad-related object (e.g., an ad group object). In addition, the channel abstraction interface module 118 can interact with the ad engine 120 to perform other functions, such as customer service-related tasks (e.g., creating an account for a new user, changing a manner of payment of an existing user, and so on). For this reason, when this description states that “ad information” is exchanged between the channel abstraction interface module 118 and the ad engines 116, that term should be construed liberally to refer to any information that pertains to a particular ad campaign as well as more general information that pertains to ad-related services, etc.

The channel abstraction interface module 118 can optionally include additional features. For example, the channel abstraction interface module 118 can apply information that was previously supplied by an appropriate client module (or by some other source) in the course of preparing information to be sent to an ad engine or in the course of interpreting information received from an ad engine. For example, an appropriate client module (or some other source) may have previously specified targeting information that identifies the region to which its ad objects are to be targeted. The channel abstraction interface module 118 can automatically apply this previously collected targeting information when preparing ad information to be sent to an ad engine (e.g., without requiring the user to re-supply this targeting information).

By virtue of the channel abstraction interface module 118, the ad system 102 can interact with any type of ad engine, including newly introduced ad engines (e.g., that were not contemplated at the time of the design of the ad system 102). To interact with a new ad engine, a designer may choose to plug in a new channel interface module into the channel abstraction interface module 118 which is appropriate for the new ad engine. This allows the ad system 102 to be upgraded in an efficient manner, e.g., without requiring re-engineering of the ad service module 104. The use of the client abstraction interface module 108 also contributes to the flexibility of the ad system 102 as a whole.

The ad service module 104 also interacts with a data interface module 136. The data interface module 136 manages the storage and retrieval of ad information based on an object model. The ad information itself can be stored and retrieved from one or more data stores 138 (referred to in the singular below for brevity).

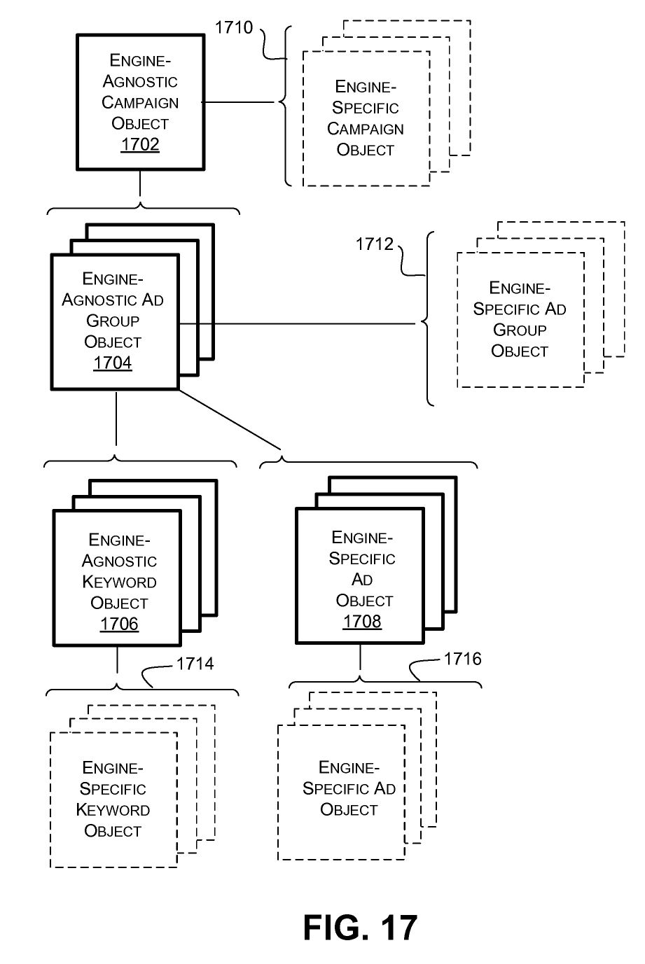

FIG. 17, to be discussed below in turn, provides additional information regarding the object model that the data interface module 136 can use to manage ad information. By way of preview, the data interface module 136 can store objects associated with different levels of an ad campaign. For example, the data interface module 136 can store ad campaign objects, ad group objects, keyword objects, and ad objects. Further, the data interface module 136 can store each object in two parts. For example, consider the case of a keyword object of an ad group that is implemented by a particular ad engine. The data interface module 136 can store a first object that expresses the engine-independent (e.g., the engine-agnostic) aspects of the keyword object and a second object that expresses the engine-specific aspects of the keyword object. The same applies to other types of objects associated with an ad campaign. Again, FIG. 17 will clarify this aspect of the data interface module 136.

Finally, FIG. 1 shows that the ad service module 104 may receive performance information that reflects how well an ad campaign is performing. A first subset of performance information may originate from one or more of the ad engines 116. For example, FIG. 1 shows that the ad service module 104 receives estimated and/or actual performance information 140 from the representative ad engine 120. A second subset of information may originate from the client modules 106 (or any other performance-monitoring entities other than the ad engines 116). For example, FIG. 1 shows that the ad service module 104 receives actual performance information 142 from the representative client module 110. For example, consider the case in which the representative client module 110 corresponds to a system that is capable of tracking ad conversions. An ad conversion occurs when a recipient-type user takes some defined desirable action with respect to an ad object. For example, an ad conversion may constitute a user's purchase of an advertised item, a user's request for additional information regarding a particular topic, a user's filling out of a form, and so on. In this case, the representative client module 110 can forward ad conversion information to the ad service module 104. The ad service module 104 can use this conversion information to assess the effectiveness of an ad campaign, particularly when this conversion information is combined with other performance data provided by the ad engines 116.

A.2. Presentation Module and Associated User Interface Presentations

FIG. 2 shows a presentation module 202 (which was not shown in FIG. 1 for brevity) that can be optionally used to present a collection of user interface (UI) presentations 204. The UI presentations 204 can allow an advertiser-type user to interact with the ad system 102 to manage an ad campaign.

The presentation module 202 acts as an interface between the client modules 106 and the ad service 104. In one illustrative and non-limiting example, the presentation module 202 includes a user interface (UI) platform module 206. The UI platform module 206 handles the interaction between the client modules 106 and the ad service module 104, abstracting the particulars of the UI presentations 204 from the client modules 106 and the ad service module 104. This feature makes the ad system 102 flexible in design. For instance, this feature allows the UI presentations 204 to be changed in various ways without impacting the way in which the ad service module 104 works.

The next series of figures shows an illustrative collection of UI presentations 204. These UI presentations 204 can be displayed by a computer device that is directly associated with a client module, or a computer device that is coupled to a client module (e.g., in the case in which the client module itself represents a server-implemented system). The user (e.g., the advertiser-type user) can interact with these UI presentations 204 using a key input device, a mouse-type interaction device, and/or any other type of interaction device.

It should be noted that the UI presentations 204 represent only one non-limiting way to create and manage an ad campaign. Other implementations can provide collections of user interface presentations which vary from the illustrated UI presentations 204 in any respect or combination of respects. For example, other implementations can present additional UI presentations (compared to the collection of UI presentations 204 shown in the figures). Other implementations can vary the sequence of the UI presentations 204 (compared to the illustrated sequence). Other implementations can vary the selection and/or arrangement of content within the UI presentations 204 (compared to the illustrated selection and arrangement of content). Other implementations can vary the look and feel of the UI presentations 204 (compared to the illustrated look and feel), and so on.

Starting with FIG. 3, this figure shows a UI presentation 300 that presents a list display section 302. The list display section 302 provides a list of ad groups associated with an ad campaign. The columns of the list display section 302 convey various items of information regarding the identified ad groups. For example, for a particular ad group, the information may specify the status of the ad group (e.g., whether it is active or inactive, etc.), the start date of the ad group, the end date of the ad group, a budget associated with the ad group, and so on. In general, the list display section 302 can provide any type of information associated with the ad groups; the items of information shown in FIG. 3 are merely representative. The UI presentation 300 also includes a total display section 304. The total section 304 provides total-related information by aggregating the information in the list display section 302.

The UI presentation 300 also includes a prompt 306 that invites the user to ad a new ad group. Presume that the user selects this prompt 306. This action will initiate a series of UI presentations (to be discussed) that solicit information from the user regarding the creation of a new ad group. In one illustrative implementation, the presentation module 202 can present these series of UI presentations in a wizard-type sequence. The user can move forward and back through the sequence of user interface presentations by activating a Forward command and Back command, respectively.

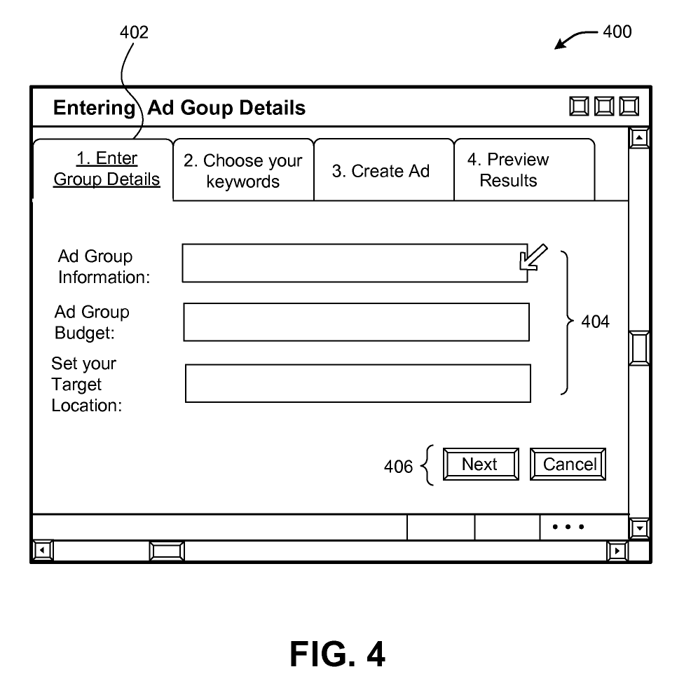

FIG. 4 shows a UI presentation 400 that may serve as a first page in the wizard-type presentation. As indicated by action bar 402, the process of creating an ad group can be divided into four phases: 1) entering group details; 2) choosing keywords; 3) creating ads; and 4) previewing results. The UI presentation 400 is associated with the first phase, namely entering group details. To that end, the UI presentation 400 includes an information collection section 404 for collecting ad group details. These details can include ad group information (pertaining to any high-level information associated with the ad group), ad group budget information, target location information, and so on. The ad group budget information defines a budget associated with the ad group. In one case, the target location information corresponds to a target location to which the ad group is directed. More specifically, different types of ad engines can accommodate the selection of different types (and combinations of types) of targeting information. Another type of targeting information can target ad objects based on temporal considerations (e.g., targeting ad objects to certain days of the week, times of the day, etc.). Another type of targeting information can target ad objects based on any type (or types) of user-related information (e.g., targeting ad objects based on age group, gender, etc.), and so on.

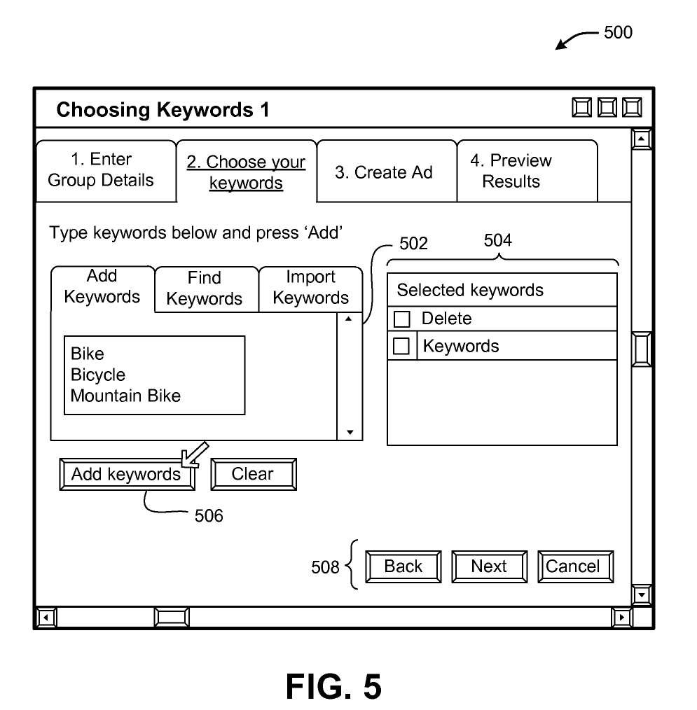

Wizard-type commands 406 allow the user to advance to the next UI presentation in the sequence of UI presentations, which is UI presentation 500 of FIG. 5. This UI presentation 500 corresponds to a keyword selection phase of the ad group creation process. The UI presentation 500 includes a keywords selection section 502 for allowing a user to specify one or more keywords to be associated with the new ad group that the user is creating. The keywords selection section 502 includes plural tabbed options. In an option “Add keywords” shown in FIG. 5, the user has typed in the merely representative three keywords of bike, bicycle, and mountain bike. The UI presentation 500 also includes a selected keywords section 504 for displaying the selected keywords. The user can move the keywords shown in the keywords selection section 502 to the selected keywords section 504 by activating an “Add keywords” command 506. Again, the user can advance to the next UI presentation by activating the “Next” command within the wizard-type commands 508.

As indicated by the tabs in the keywords selection section 502, there are other approaches that a user can take to select keywords. According to the “Find Keywords” selection option, the user can select keywords using different find-related methods. In one such method, the user can find desired keywords by entering a term; the ad service module 104 responds by returning one or more (if any) keywords that are deemed similar to the entered term. In another method, the user can instruct the ad system 102 to search any type of content to automatically extract one or more keywords therefrom based on any search criterion or combination of search criteria. The identified content may correspond to network-accessible content (e.g., a web page or a collection of web pages), any type of advertising documents provided by the user, and so on). There are still other ways of finding keywords on behalf of the user using the “Find Keywords” selection option. According to an “Import Keywords” selection option, the user can alternatively import keywords from an identified source, such as an identified spreadsheet document, etc.

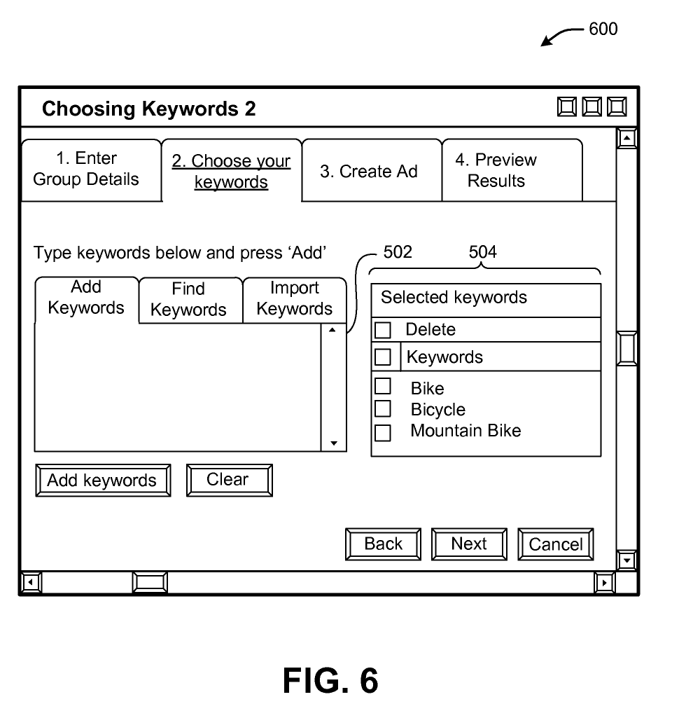

FIG. 6 shows a UI presentation 600 that illustrates the result of the user activating the “Add keywords” command 506 in FIG. 5. As described above, activating this command 506 prompts the ad system 102 to move the selected keywords in the keywords selection section 502 to the selected keywords section 504.

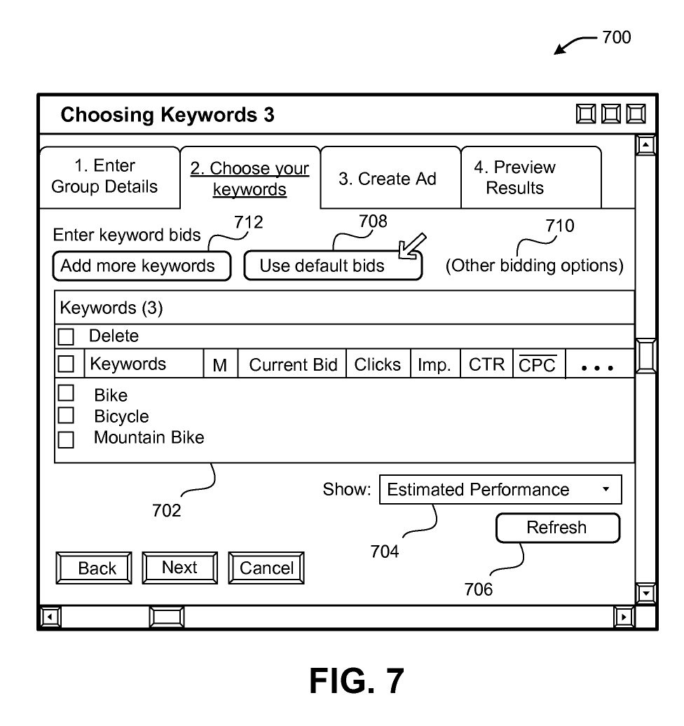

FIG. 7 shows a UI presentation 700 that presents, in a keyword display section 702, a list of the keywords that were selected in the manner described above. As explained, the user has selected three keywords for the ad group being created, namely, bike, bicycle, and mountain bike. The keyword display section 702 also presents information regarding the performance of the keywords in a number of identified categories, e.g., clicks, impressions, CTR (click-through rate), average CPC (average cost-per-click), and so on. The selection of performance metrics illustrated in FIG. 7 is representative; other implementations can provide a different collection of metrics. As per a selection made in menu part 704, the keyword display section 702 is configured to display the estimated performance of the keywords, rather than the actual performance. This is appropriate because the ad group has not been launched, so there may not be any actual performance data to gauge the effectiveness of the newly created ad group. As explained above, one or more ad engines (that will be used to implement the ad group being created) can furnish the performance estimates displayed in the keyword display section 702. The ad engines can provide the estimated performance based on historical records which they maintain and/or based on other considerations. The user can refresh (e.g., update) the estimate performance information shown in the keyword display section 702 by activating a “Refresh” command 706.

The UI presentation 700 also includes a number of command options that allow a user to associate bids with the keywords. In one case, the user can activate a “Use default bids” command 708 to apply a default bid to one or more identified keywords (e.g., by clicking the boxes associated with the identified keywords). The user may have previously specified the amount associated with the default bid. The UI presentation 700 can optionally include other functionality for selecting bids. For example, the UI presentation 700 can include appropriate command functionality 710 for optimizing the bid selection based on one or more considerations. Finally, the UI presentation 700 can include an “Add more keywords” command 712 that allows a user to add one or more keywords to the list of keywords shown in the keyword display section 702.

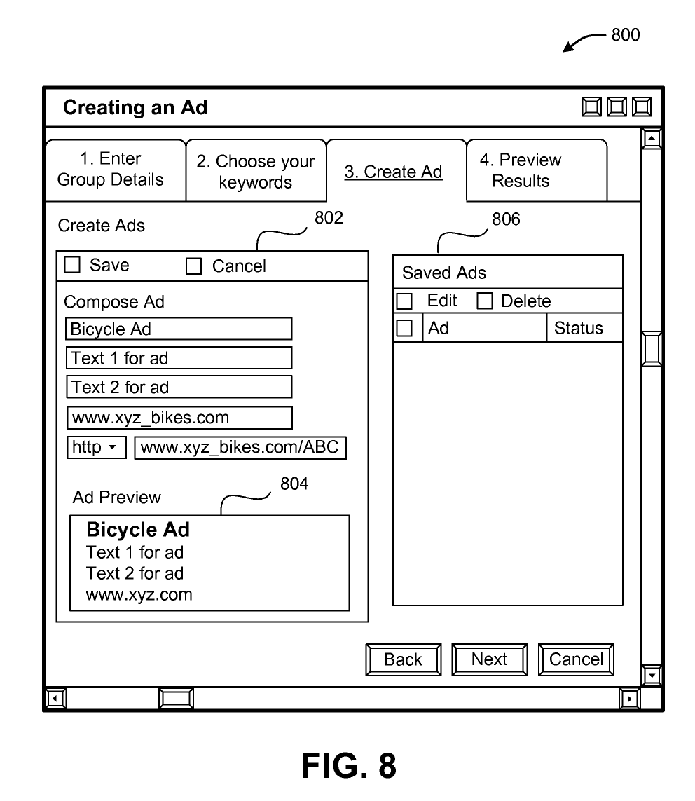

FIG. 8 shows a UI presentation 800 that implements a next phase in the process of creating an ad group, namely, creating an ad object. The ad object defines the message content that will be presented upon the occurrence of a keyword-triggering event. The UI presentation 800 includes an ad composition section 802 for allowing a user to compose the ad object, e.g., by specifying its text content and its associated network address. The network address identifies the network-accessible content that will be presented when the user activates the ad object. The ad composition section 802 also includes an ad preview section 804 for displaying how the ad object that is being created will appear when presented to a recipient-type user. The UI presentation 800 also includes a saved ad section 806. The saved ad section 806 shows the ad object that the user has saved by activating a “Save” command in the ad composition section 802.

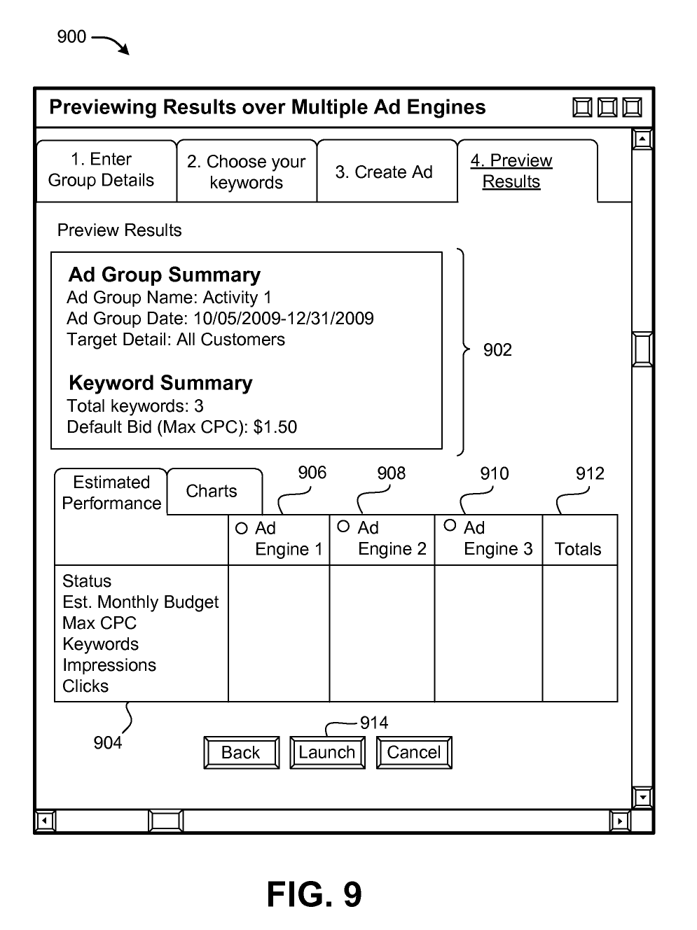

FIG. 9 shows a UI presentation 900 that implements a next phase in the process of creating an ad group, namely, that of previewing the ad group that has been created. This UI presentation 900 includes an ad group summary section 902 for presenting high level summary information regarding the newly created ad group. The UI presentation 900 also includes a performance display section 904 for presenting the performance of the newly created ad group. Because the ad group has just been created, the performance display section 904 can display the estimated (rather than actual) performance of the ad group. As explained above, the ad service module 104 can collect estimated performance data from each ad engine that will be used to implement the ad group.

Assume, merely by a way of example, that the newly created ad group relies on three ad engines to implement the ad group, namely, ad engine 1, ad engine 2, and ad engine 3 (associated with ad engines 120, 122, and 124 shown in FIG. 1). In one case, the ad engines that are chosen to implement the ad group can be selected based on a default setting associated with a particular advertiser-type user. In another case, the ad engines that are chosen can be custom-selected by the user. In the case in which three ad engines are being used, the performance display section 904 can include columns (906, 908, 910) that present performance information associated with each respective ad engine. A final column 912 can present total information which aggregates the performance information in the preceding three columns (906, 908, 910).

By virtue of the above-described type of multi-engine display, a user can be effectively apprised of the relative merits of each of the ad engines. That is, this aspect allows the user to readily compare the estimated performance of the three selected ad engines. This provides useful insight that has a possible bearing on how a user may wish to structure the ad group that is being created, as described below.

One category of information displayed in the performance display section 904 is estimated monthly budget. Different techniques can be used to select budget amounts associated with different ad engines. In one case, the user can custom-select the budget amounts to be applied to each ad engine. For instance, based on the estimated performance of the ad engines, the user may wish to vary the budget amounts applied to the ad engines, e.g., so as to favor the ad engine(s) that are projected to perform better than other ad engine(s). In another case, the user may enter a single budget amount associated with the ad group. The ad service module 104 can respond by dividing the budget amount generally equally among the three ad engines. Or the ad service module 104 can replicate the entered budget amount for each of the three ad engines (such that, if the user enters a total budget of $10,000, each ad engine may receive a budget of $10,000). In another case, the ad service module 104 can automatically allocate the entered budget amount among the ad engines in a manner that is generally proportional to the estimated performance (and/or, if available, actual performance) of the ad engines, e.g., such that an ad engine that is projected to be more successful than another ad engine may receive a larger share of the budget than the other ad engine. Still other ways of allocating budget among the ad engines are possible.

In one case, the user can simultaneously launch the ad group on all of the applicable ad engines (in this case, engines 1, 2, and 3) by activating a “Launch” command 914 at the bottom of the UI presentation 900. In another case, the user can selectively launch the ad group on some ad engines but not others. In one case, for instance, the user may wish to receive additional information regarding the ad group in the context of its implementation on a particular ad engine. The user may also wish to make custom selections which vary the implementation of the ad group on a particular ad engine.

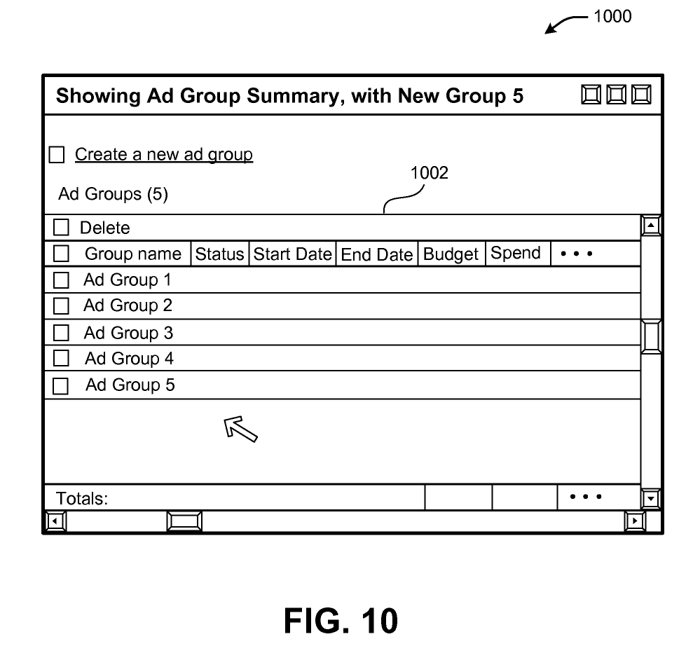

FIG. 10 shows a UI presentation 1000 that is the counterpart of the UI presentation 300 shown in FIG. 3. Namely, the UI presentation 1000 shows a list display section 1002 that shows a list of ad groups associated with an ad campaign. The user has just created a new ad group, namely, ad group 5. Hence, the list display section 1002 shows this new ad group.

In addition to creating a new add group, the UI presentations 204 provide functionality that allows a user to edit any aspect of an existing ad group (or groups). The UI presentations 204 also allow the user to monitor the performance of an existing ad group (or groups). For example, assume that the user wishes to monitor the performance of ad group 5 (which has just been created), and/or the user wishes to edit any aspect of ad group 5. The user can initiate these actions by activating the ad group 5 entry within the list display section 1002 of FIG. 10.

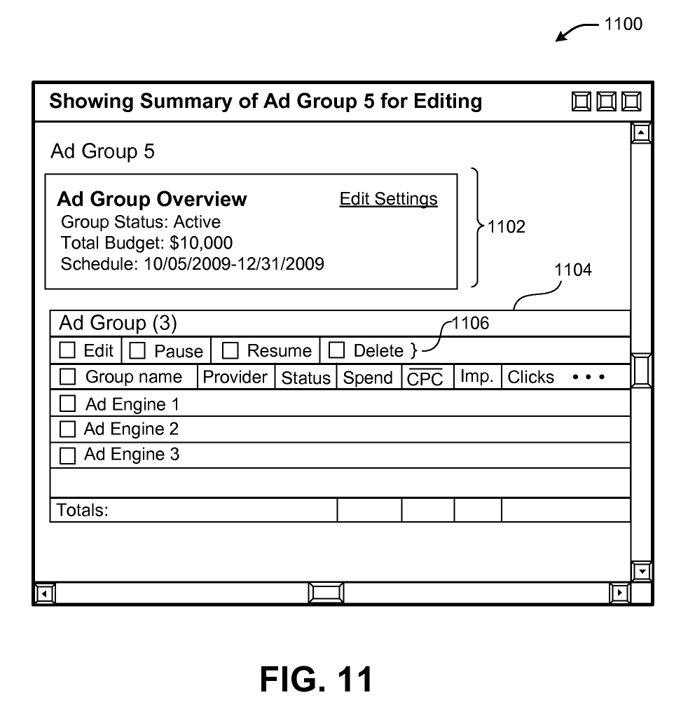

The user's selection prompts the presentation of the UI presentation 1100 shown in FIG. 11. The UI presentation 1100 includes an overview display section 1102 that presents overview information associated with the ad group 5. The overview display section 1102 also includes an “Edit Settings” command which allows the user to edit high level settings associated with this ad group. The UI presentation 1100 also includes a performance summary section 1104 that, in part, shows performance information associated with the ad group on an engine-by-engine basis for various metrics-related categories. This performance information may reflect the actual performance of the ad group, the estimated performance of the ad group, or a combination of the estimated performance and the actual performance of the ad group. The actual performance information can be gleaned from the ad engines 116, from the relevant client module (or some other performance monitoring system), and/or from some combination thereof.

The UI presentation 1100 also includes a menu part 1106 that allows a user to edit the ad group, to pause the ad group, to resume a previously paused ad group, to delete an ad group, etc. These operations can be performed on a per-engine level of granularity by selecting appropriate ad engines (e.g., by clicking on the boxes associated with the ad engines).

The next UI presentation 1200 shows the performance of the ad group 5 on a per-keyword basis (for ad engine 1). That is, a performance display section 1202 shows the performance of each keyword in the ad group for various metrics-related categories. Again, if actual performance is presented, the actual performance can be gleaned from the ad engines 116, from the relevant client module (or other relevant data collection system), etc., or any combination thereof.

The performance display section 1202 also includes a menu part 1204 that allows a user to edit existing keywords, edit existing keyword properties, delete existing keywords, export existing keywords to a target destination, and so on. The user can perform these operations on a per-keyword basis by selecting keywords (e.g., by clicking on the boxes associated with the keywords). The UI presentation 1200 also includes an “Add keywords” command 1206 that allows a user to add new keywords to the ad group.

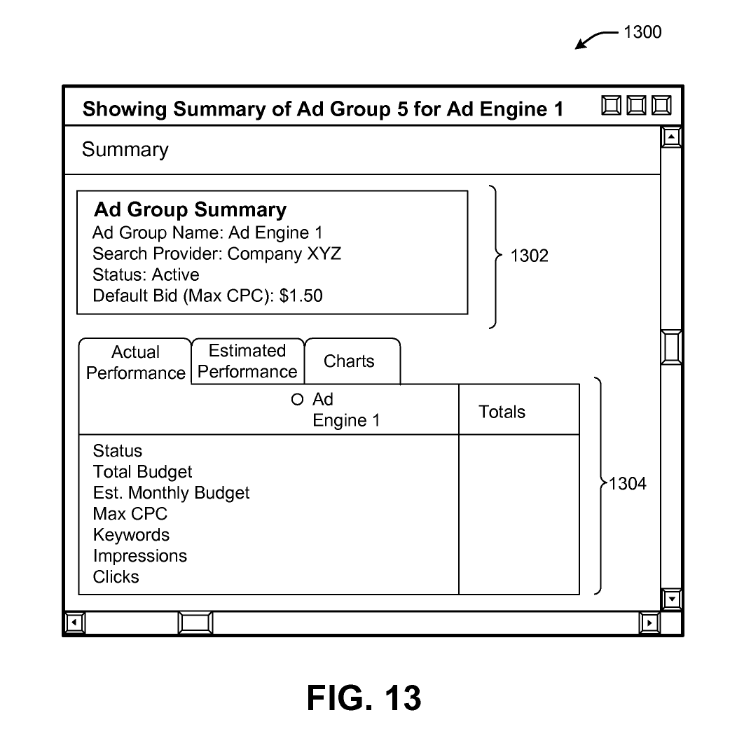

Finally, a UI presentation 1300 shown in FIG. 13 presents additional information regarding ad engine 1's implementation of ad group 5. The UI presentation 1300 includes an ad group summary section 1302 which presents an overview of information regarding the ad engine per se and information regarding this ad engine's implementation of the ad group. The UI presentation 1300 also includes a performance display section 1304 that displays the performance of the ad engine (in implementing the ad group 5). More specifically, a first selectable tabbed part of the performance display section 1304 provides information regarding the actual performance of the ad engine. A second selectable tabbed part of the performance display section 1304 provides information regarding the estimated performance of the ad engine. A third selectable tabbed part of the performance display section 1304 may provide any type of performance information in chart format.

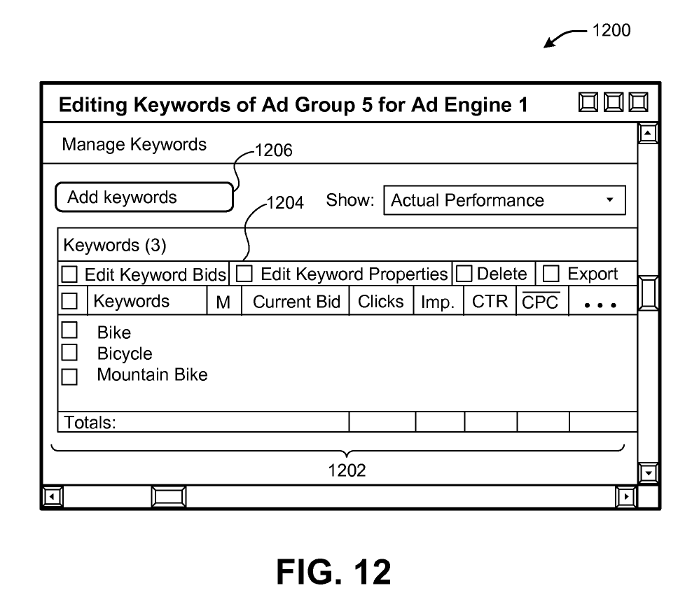

To repeat, the series of UI presentations 204 shown in FIGS. 3-13 is representative and non-limiting. Other implementations can provide other collections of user interface presentations that vary in any respect or combination of respects from the UI presentations 204 illustrated herein.

A.3. Ad Service Module

FIG. 14 shows additional information regarding the ad service module 104 introduced in the context of FIG. 1. As described above, the ad service module 104 can manage an ad campaign. An ad campaign, in turn, can include one more ad groups. Each ad group can include one or more keywords and one or more ad objects. The ad service module 104 can manage the ad campaign on any level of granularity, such as the ad campaign level, the ad group level, the keyword level, the ad object level, and so on.

FIG. 14 shows some of the functions that can be performed by the ad service module 104 from a high-level perspective. For example, the ad service module 104 can include creation functionality 1402 that allows a user to create any aspect of an ad campaign. The ad service module 104 can also include monitoring and reporting functionality 1404 for monitoring the performance of any aspect of an ad campaign. As described in the preceding subsection, the ad service module 104 can report the estimated performance of the ad campaign, the actual performance of the ad campaign, or some combination thereof. The ad service module 104 can also include editing functionality 1406 for editing any aspect of an ad campaign.

The ad service module 104 can perform yet other functions. For example, the ad service module 104 can also include administrative functionality 1408 that allows a user to perform administrative operations that may affect one or more ad engines, such as by signing up for a particular service offered by one or more ad engines, specifying account settings (e.g., changing a manner of payment), and so on.

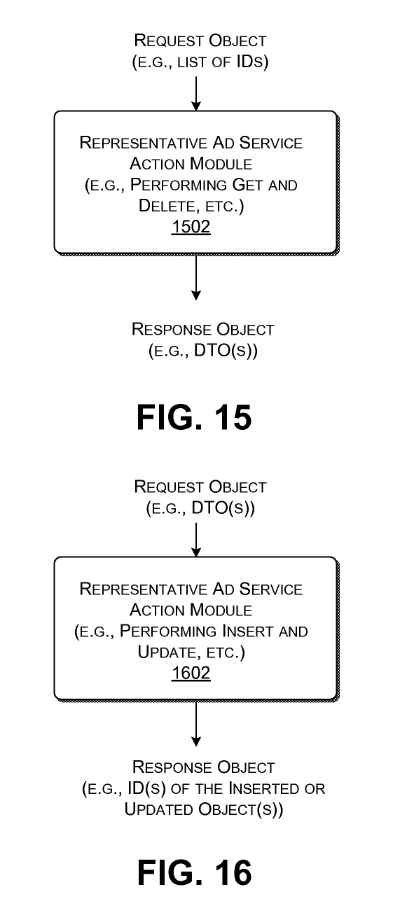

Different techniques can be used to implement the ad service module 104. FIGS. 15 and 16 show one illustrative technique that uses ad service action modules to perform a set of operations. Each of these ad service action modules accepts a request object and returns a response object. One illustrative way of implementing these ad service action modules is using Application Programming Interface (API) functionality.

More specifically, FIG. 15 shows an ad service action module 1502 that is representative of a first type of action module. This ad service action module 1502 accepts a list that includes one or more IDs. The IDs are associated with ad information objects. The ad service action module 1502 returns one or more data transfer objects (DTOs). For example, the ad service action module 1502 can be applied to a Get operation and a Delete operation. For example, assume that the user wishes to delete a keyword object. The ad service action module 1502 receives an ID associated with the keyword object to be deleted and then returns a DTO associated with the deleted keyword object. Or assume that the user wishes to retrieve an ad group object. The ad service action module 1502 receives an ID associated with the ad group object to be retrieved and then returns a DTO associated with the corresponding ad group object.

FIG. 16 shows an ad service action module 1602 that is representative of a second type of action module. This ad service action module 1602 accepts one or more DTOs and returns a list of IDs that are associated with some action that has been performed on the input DTOs. For example, the ad service action module 1602 can be applied to an Insert operation and an Update operation. For example, assume that the user wishes to update an ad group object. The user can edit the ad group object to create a DTO that is associated with the updated ad group object. The ad service action module 1602 returns an ID that will henceforth be associated with the updated ad group object.

In addition to the scenarios described above, the ad service action modules (1502, 1602) can also return error information. For example, the ad service action modules (1502, 1602) can validate input information provided by the user against a set of rules which define permissible input. For example, the ad service action modules (1502, 1602) can examine ad content to make sure that it does not contain invalid characters, words, etc. In another example, the ad service action modules (1502, 1602) may identify an updated budget amount of $0 as erroneous. Generally, the ad service action modules (1502, 1602) can generate error information if the input information does not conform to the rules. The ad service action modules (1502, 1602) can also provide guidance to the user that assists the user in addressing an error. The ad service action modules (1502, 1602) can also optionally report error conditions that are identified by the external ad engines 116 in processing requests.

A.4. Data Interface Module and Associated Data Model

As introduced in the discussion of FIG. 1, the data interface module 136 stores ad information in the data store 138 and retrieves ad information from the data store 138. The data interface module 136 applies a data model to govern the manner in which it formats the ad information that it stores and retrieves.

FIG. 17 shows an example of how ad information associated with an ad campaign can be expressed based on one illustrative data model. Other data models can optionally be used instead of the data model shown in this figure. Or the ad system 102 can omit the use of a data model.

As shown in FIG. 17, the data interface module 136 may allocate objects to different levels of ad information in an ad campaign based on the data model. For example, the ad information can include an ad campaign object 1702 associated with the ad campaign as a whole. The ad information can also include one or more ad group objects (such as representative ad group object 1704) associated with ad groups within the ad campaign. The ad information can also include one or more keyword objects (such as representative keyword object 1706) associated with keywords used by the ad group(s). The ad information can also include one or more ad objects (such as representative ad object 1708) associated with ad objects used by the ad group(s).

More specifically, the data interface module 136 can express ad information using two different types or categories of objects. A first type of object expresses ad information that is independent of the ad engines (e.g., engine-agnostic ad information). A second type of object expresses ad information that is specific to the ad engines (e.g., engine-specific ad information). For example, the representative ad campaign object 1702 may correspond to an engine-agnostic campaign object, while a set of other objects 1710 may correspond to engine-specific detail associated with respective ad engines used to implement the ad campaign. The representative ad group object 1704 may correspond to an engine-agnostic ad group object, while a set of other objects 1712 may correspond to engine-specific detail associated with respective ad engines. The representative keyword object 1706 may correspond to an engine-agnostic keyword object, while a set of other objects 1714 may correspond to engine-specific detail associated with respective ad engines. The representative ad object 1708 may correspond to an engine-agnostic ad object, while a set of other objects 1716 may correspond to engine-specific detail associated with respective ad engines.

Consider the case of a keyword used in an ad group. An engine-agnostic keyword object may include at least the textual content associated with the keyword, which may not vary from ad engine to ad engine. An engine-specific counterpart to this engine-agnostic keyword object may include information such as maximum CPC, CTR, status information, etc., which is information that can be expected to vary from ad engine to ad engine. More generally, the engine-specific objects can include at least ID information that can be used by the associated ad engines to locate referenced ad information objects (that the ad engines maintain based on their respective native protocols for storing ad information).

A.5. Channel Abstraction Interface Module

FIG. 18 shows additional information regarding the channel abstraction interface module 118 that was introduced in the context of FIG. 1. As stated there, in one use, the channel abstraction interface module 118 converts between an engine-agnostic expression of ad information and an engine-specific expression of ad information. The engine-agnostic manner of expressing the ad information is native to the ad system 102, while the engine-specific expression of the ad information is native to a particular ad engine.

More specifically, FIG. 18 shows additional details regarding the common interface module 128 used by the channel abstraction interface module 118. The common interface module 128 implements a set of methods (e.g., API-type methods in one example) for performing tasks in a uniform manner. That is, the methods are engine-agnostic in the sense that they do not take account of the particularities of the unique protocols used by the ad engines 116. As explained above, it is the role of the channel interface modules (130, 132, . . . 134) to allow the general methods of the common interface module 128 to successfully interact with the associated ad engines 116.

A first category of methods provides campaign processing functionality 1802. The campaign processing functionality 1802 provides methods for creating and updating ad groups, ad objects, keywords, and so on. A second category of methods provides customer service functionality 1804. The customer service functionality 1804 handles customer service-related tasks, such as establishing a user account, terminating a user account, changing account settings (e.g., payment options, etc.), and so on. A user account gives an advertiser-type user the right to use the services of a particular ad engine. A third category of methods provides reporting functionality 1806. The reporting functionality 1806 provides reports to the user regarding the performance of an ad campaign. The performance information used to compile these reports can be obtained from the ad engines 116.

Consider an illustrative example. Suppose that the ad service module 104 invokes the Create Ad Groups method provided by the common interface module 128. This method is used to instruct the representative ad engine 120 to create an ad group. The Create Ad Groups method may act on a data structure that expresses an ad group in an engine-agnostic way. For example, the data structure may specify the name of the ad group, the monthly budget of the ad group, the start date of the ad group, the end date of the ad group, targeting information associated with the ad group, and status information associated with the ad group. This selection and arrangement of information items may not (or may) match any of the protocols used by the ad engines 116 in accepting orders for new ad groups. For example, assume that the representative ad engine 120 expects its users to specify budget information on a daily basis, rather than monthly. In this case, the channel interface module 130 can convert the monthly budget information specified by the common interface module 128 to a daily format (which is the format expected by the ad engine 120). This is merely one example of translation operations that can be performed by the channel interface modules (130, 132, . . . 134).

FIG. 18 also illustrates an “interface to object module” 1808. As the name suggests, this module 1808 allows the channel abstraction interface module 118 to interact with the data model used by the data interface module 136. The “interface to object module” 1808 is not part of the channel abstraction interface module 118 per se, but rather sits between the data interface module 136 and the channel abstraction interface module 118. It is used, in part, to allow external entities to interact with the ad information provided by the ad system 102 without exposing the internal representation of the ad information maintained by the ad system 102.

B. Illustrative Processes

The next series of figures shows the concepts described above in flowchart form. As the concepts have already been explained, this section will primarily serve as a review of the above discussion.

B.1. Overview

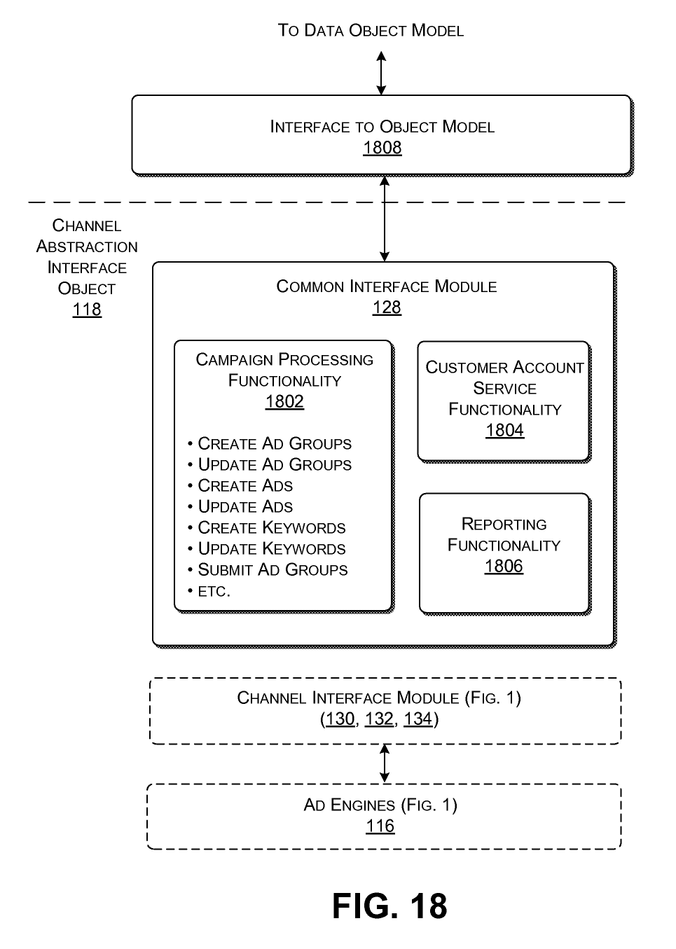

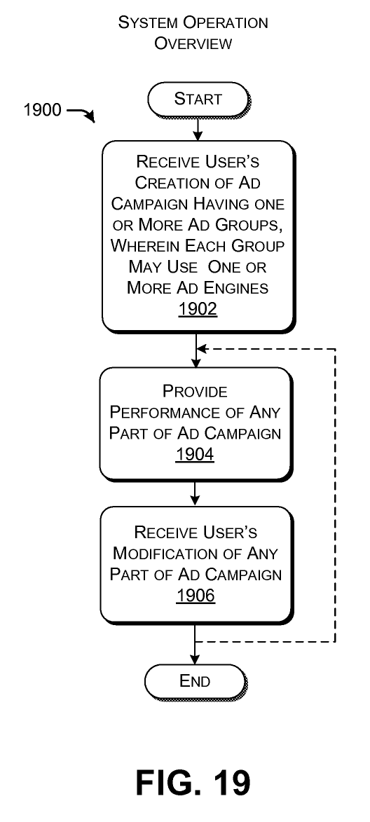

Starting with FIG. 19, this figure shows a procedure 1900 which provides an overview of the operation of the ad system 102 of FIG. 1 (or some other system).

In block 1902, the ad system 102 receives the user's creation of an ad campaign having one or more ad groups, where each ad group, in turn, can include one or more keywords and one or more ad objects.

In block 1904, the ad system 102 provides performance information (actual and/or estimated) pertaining to any part of an existing ad campaign.

In block 1906, the ad system 102 receives the user's modification (e.g., editing) of any part of an existing ad campaign. The dashed lines indicate that blocks 1904 and 1906 can be repeated throughout the life of an ad campaign as desired.

B.2. Creating, Reviewing, and Editing an Ad Campaign

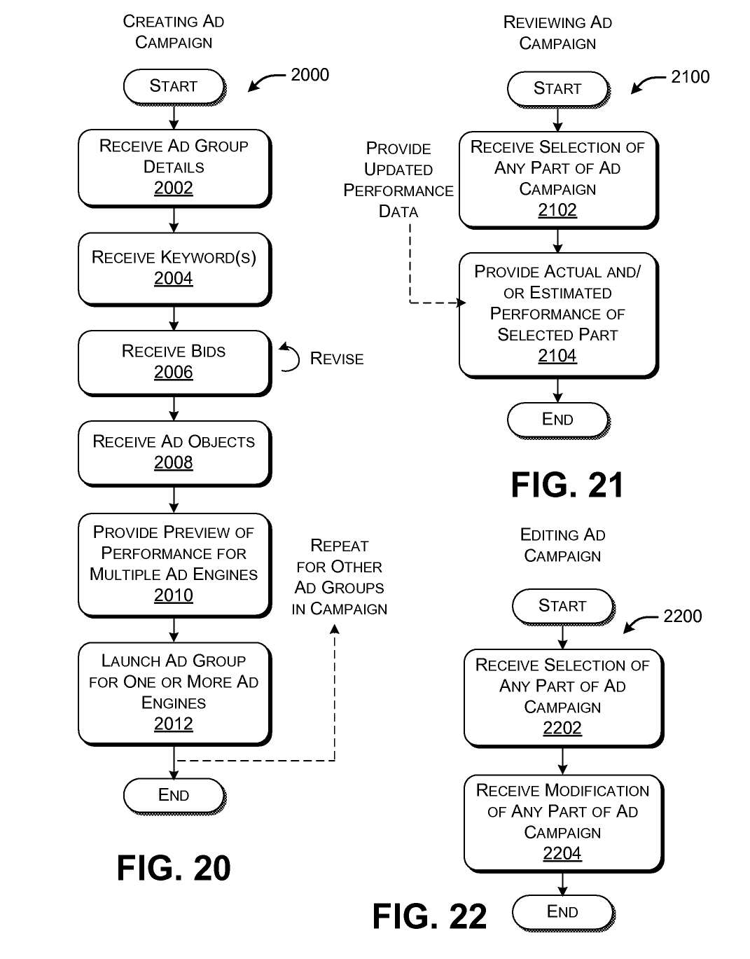

FIG. 20 shows a procedure 2000 which explains how the ad system 102 (or some other system) can be used to create an ad campaign. The user may create the ad campaign by creating each ad group in the ad campaign in turn.

In block 2002, the ad system 102 can receive the user's specification of ad group details. The ad group details provide high-level details associated with the ad group, such as the budget of the ad group.

In block 2004, the ad system 102 can receive the user's selection of one or more keywords to be associated with the ad group.

In block 2006, the ad system 102 can receive the user's selection of bids associated with the selected keywords.

In block 2008, the ad system 102 can receive the user's selection of one or more ads to be associated with the ad group.

In block 2010, the ad system 102 can present a preview the performance of the ad group. At this stage, the performance may pertain to the estimated performance of the ad group. The ad system 102 can display the performance on an engine-by-engine basis, a keyword-by-keyword basis, or in some other form.

In block 2012, the system 102 can receive the user's instruction to launch the ad group (or only parts thereof). This block ultimately instructs the associated ad engines to commence presenting the ad objects in response to keyword-triggering events.

FIG. 21 shows a procedure 2100 which explains how the ad system 102 (or some other system) can allow a user to review ad information associated with an existing ad campaign.

In block 2102, the ad system 102 receives the user's selection of any part of the ad campaign to be monitored. For example, the user may wish to view the overall performance of an ad group (or plural ad groups). Or the user may wish to view more detailed information regarding the performance of an ad group, such as the performance of an individual keyword used by the ad group, or the performance of a particular ad engine used by the ad group, and so forth.

In block 2104, the ad system 102 provides estimated and/or actual performance of the selected part(s) of the ad campaign.

FIG. 22 shows a procedure 2200 which explains how the ad system 102 (or some other system) can allow a user to edit any part of an ad campaign.

In block 2202, the ad system 102 receives the user's selection of any part of the ad campaign to be edited. For example, the user may wish to edit all of an ad group or some part thereof (such as an individual keyword or individual keywords used by the ad group).

In block 2204, the ad system 102 receives and stores the user's modification of the selected part(s) of the ad campaign.

B.3. Operation of the Channel Abstraction Interface Module

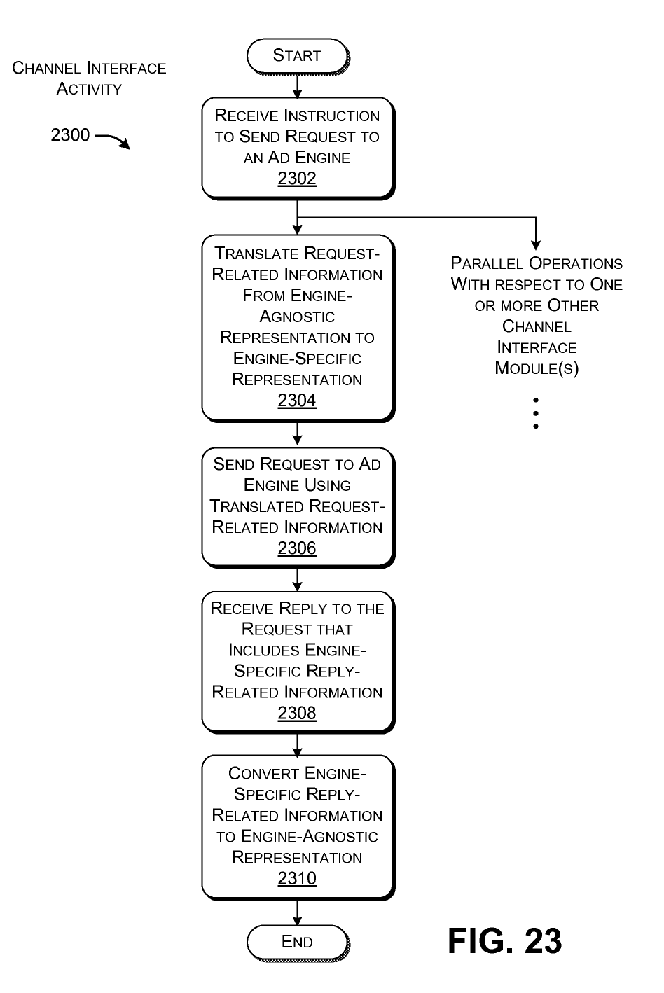

FIG. 23 shows an illustrative procedure 2300 which explains how any of the channel interface modules (130, 132, . . . 134) (such as the representative channel interface module 130) can be used to interact with the ad engines 116 (such as the ad engine 120).

In block 2302, the channel interface module 130 is asked to send some type of request to the ad engine 120. For example, the request may ask the channel interface module 130 to contact the ad engine 120 to create a new ad information object, to update an existing ad information object, to perform some administrative task associated with a user account, and so on.

In block 2304, the channel interface module 130 translates request-related information associated with the request from an engine-agnostic format (that is used by the ad system 102) to an engine-specific format associated with the ad engine 120.

In block 2306, the channel interface module 130 sends the request to the ad engine 120. The request includes the translated request-related information. In one non-limiting case, the channel interface module 130 can send the request to the ad engine 120 via a web service exposed by the ad engine 120.

In block 2308, the channel interface module 130 receives a reply from the ad engine 120 that includes engine-specific reply-related ad information.

In block 2310, the channel interface module 130 converts the engine-specific reply-related ad information to an engine-specific agnostic form for processing by the ad system 102.

C. Representative Processing Functionality

FIG. 24 sets forth illustrative electrical data processing functionality or equipment 2400 (simply “processing functionality” below) that can be used to implement any aspect of the functions described above. With reference to FIG. 1, for instance, the type of processing functionality 2400 shown in FIG. 24 can be used to implement any aspect of the ad system 102. The type of processing functionality 2400 shown in FIG. 24 can also be used to implement any aspect of the client modules 106. The type of processing functionality 2400 shown in FIG. 24 can also be used to implement any aspect of the ad engines 116, and so on. In one case, the processing functionality 2400 may correspond to any type of computing device.

The processing functionality 2400 can include volatile and non-volatile memory, such as RAM 2402 and ROM 2404, as well as one or more processing devices 2406. The processing functionality 2400 also optionally includes various media devices 2408, such as a hard disk module, an optical disk module, and so forth. The processing functionality 2400 can perform various operations identified above when the processing device(s) 2406 executes instructions that are maintained by memory (e.g., RAM 2402, ROM 2404, or elsewhere). More generally, instructions and other information can be stored on any computer-readable medium 2410, including, but not limited to, static memory storage devices, magnetic storage devices, optical storage devices, and so on. The term “computer-readable medium also encompasses plural storage devices. The term computer-readable medium also encompasses signals transmitted from a first location to a second location, e.g., via wire, cable, wireless transmission, etc. The term logic encompasses instructions for performing identified tasks; for example, the presentation module 202 shown in FIG. 2 can be implemented by logic for presenting each of the user interface presentations described above.

The processing functionality 2400 also includes an input/output module 2412 for receiving various inputs from a user (via input modules 2414), and for providing various outputs to the user (via output modules). One particular output mechanism may include a presentation module 2416 and an associated graphical user interface (GUI) 2418. The processing functionality 2400 can also include one or more network interfaces 2420 for exchanging data with other devices via one or more communication conduits 2422. One or more communication buses 2424 communicatively couple the above-described components together.

In closing, the description may have described various concepts in the context of illustrative challenges or problems. This manner of explication does not constitute an admission that others have appreciated and/or articulated the challenges or problems in the manner specified herein.

More generally, although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. An ad system for administering an ad campaign, comprising:
an ad service module configured to create and manage the ad campaign;
a client interface module configured to interact with at least one client module;
a channel abstraction interface module configured to interact with plural ad engines, each ad engine providing engine-specific administration of the ad campaign, the channel abstraction interface module comprising:
a common interface module for representing ad information processed by the ad service module in an engine-agnostic format; and
plural channel interface modules associated with the plural respective ad engines, each channel interface module converting the ad information between the engine-agnostic format and a format that is appropriate for a corresponding ad engine; and
a presentation module configured to present a collection of user interface presentations, the collection of user interface presentations allowing interaction with the ad service module and the plural ad engines via the client interface module.

2. The ad system of claim 1, wherein the ad service module is configured to process the ad information using one or more ad service action modules, each ad service action module receiving a request object and generating a response object.

3. The ad system of claim 2, wherein one type of ad service action module receives, as the request object, at least one ID associated with an ad information object, and provides, as the response object, at least one data transfer object.

4. The ad system of claim 2, wherein one type of ad service action module receives, as the request object, at least one data transfer object, and provides, as the response object, at least one ID associated with an ad information object on which an action has been performed.

5. The ad system of claim 1, wherein the client interface module is configured to convert ad information between a client-specific format and a client-agnostic format that can be interpreted by the ad system.

6. The ad system of claim 1, wherein at least one user interface presentation in the collection of user interface presentations allows a user to create a new ad campaign, wherein the new ad campaign includes at least one ad group, and wherein said at least one ad group includes at least one keyword and at least one ad object.

7. The ad system of claim 1, wherein at least one user interface presentation in the collection of user interface presentations allows a user to edit an identified ad campaign.

8. The ad system of claim 1, wherein at least one user interface presentation in the collection of user interface presentations presents a performance of an identified ad campaign.

9. The ad system of claim 8, wherein the performance reflects an estimated performance of the ad campaign as assessed by the plural ad engines.

10. The ad system of claim 8, wherein the performance reflects an actual performance of the ad campaign as assessed by the plural ad engines.

11. The ad system of claim 10, wherein the actual performance is also based on conversion information provided by a conversion-monitoring system.

12. The ad system of claim 1, further comprising a user interface platform module which serves as an interface between the collection of user interface presentations and the ad service module.

13. The ad system of claim 1, further comprising a data interface module for managing ad information based on an object model, wherein the object model manages ad information objects in both an engine-agnostic storage format and an engine-specific storage format.

14. A computer-readable medium for storing computer-readable instructions, the computer-readable instructions providing a presentation module when executed by one or more processing devices, the computer-readable instructions comprising:
logic configured to present at least one user interface presentation that allows a user to create an ad campaign that is administered on plural ad engines, the ad campaign including at least one ad group, said at least one ad group including at least one keyword and at least one ad object;
logic configured to present at least one user interface presentation that allows a user to edit the ad campaign; and
logic configured to present at least one user interface presentation that displays a performance of the ad campaign, ad information being represented by a data model that separates engine-agnostic ad information from engine-specific ad information.

15. The ad system of claim 14, wherein said at least one user interface presentation that displays the performance of the ad campaign is configured to display the performance of the ad campaign on a per-engine basis.

16. A method for interfacing between an ad service module and plural ad engines, comprising:
receiving an instruction to send a request to an ad engine;
translating request-related information from an engine-agnostic representation to an engine-specific representation that is associated with the ad engine;
sending the request to the ad engine that includes the engine-specific representation of the request-related information;
receiving a reply from the ad engine, in response to the request, that includes reply-related information; and
converting the reply-related information to an engine-agnostic representation of the reply-related information,
the translating and converting using a channel abstraction interface module that is configured to interact with the plural ad engines, the channel abstraction interface module including a common interface module and plural channel interface modules, the common interface module implementing a common set of methods.

17. The method of claim 16, further comprising performing the translating, sending, receiving of the reply, and converting with respect to at least one other ad engine having its own respective engine-specific representation.

18. The method of claim 16, wherein the translating, sending, receiving of the reply, and converting are performed to provide ad information to the ad engine for use by the ad engine in administering an ad campaign.

19. The method of claim 16, wherein translating, sending, receiving of the reply, and converting are performed to receive performance information from the ad engine which reflects a performance of an existing ad campaign.

20. The method of claim 16, wherein the plural ad engines are administered by plural different entities based on plural different respective protocols.
